(19) United States
(12) Patent Application Publication
(10) Pub. No.: US 2008/0243648 A1
(43) Pub. Date: Oct. 2, 2008

(54) SYSTEM FOR REMOTELY MANAGING A HOME HEATING SYSTEM

(76) Inventors: Anthony M. Uzzo, Branford, CT (US); Anthony M. Uzzo, Guilford, CT (US); James D. Gregory, Clinton, CT (US)

Correspondence Address: ST. ONGE STEWARD JOHNSTON & REENS, LLC, 986 BEDFORD STREET, STAMFORD, CT, 06905-5619, US

(21) Appl. No.: 11/923,292

(22) Filed: Oct. 24, 2007

Related U.S. Application Data
(63) Continuation-in-part of application No. 10/072,503, filed on Feb. 6, 2002, now Pat. No. 7,292,993.
(60) Provisional application No. 60/267,249, filed on Feb. 8, 2001.

(51) Int. Cl. G06Q 10/00

(52) U.S. Cl. 705/28

(57) ABSTRACT

A centralized fuel monitoring system for allowing a plurality of fuel dealers to monitor the fuel level at customer locations, the system having a central computer accessible by the plurality of fuel dealers to access customer account information, the customer account information including an indication of a fuel level at a customer location. The fuel level may be remotely measured or may be calculated by the system. Also included is authorization software that allows a fuel dealer to access customer accounts and administration software that allows a fuel dealer to create new customer accounts.

### CROSS-REFERENCE TO RELATED APPLICATIONS

This application is a continuation-in-part of U.S. patent application Ser. No. 10/072,503 filed Feb. 6, 2002, which claims priority benefits under 35 U.S.C. §119(e) to U.S. Provisional Patent Application Ser. No. 60/267,249 filed Feb. 8, 2001.

### FIELD OF THE INVENTION

The invention relates to a system for remotely managing bulk product storage and more specifically, to managing fuel oil levels in at least one storage location.

### BACKGROUND OF THE INVENTION

Management of bulk product storage differs from management of storing unit products, such as discreet products like televisions, or pencils, in three key areas: measurement of the quantity of the stored product, replenishment of the stored product, and participant roles.

Measuring the quantity of stored unit products requires inventorying the products that are to be managed. Televisions, chairs and the like may be readily inventoried as individual units. Other items may be inventoried in the packaging unit in which they are to be distributed and sold. Thus, an office supply distributor might inventory paper in units of pallets, a down chain office supply retailer might inventory the same paper in more convenient units of boxes, and the office manager of an end consumer office may inventory the same paper in reams. Significant is that each inventory unit is capable of being hand counted. Automated inventory management tools extend that capability.

Bulk products, such as oil, coal, or grain, are inherently inconvenient or impossible to measure by eye and require different inventory methods than counting definable units. Inventorying individual units is too arduous or impossible. Since, bulk products are often needed, and thus sold, in quantities related to physical measurements, such as volume, and weight they are often inventoried as such using specialized equipment.

Replenishment of stores of bulk products are usually made by large delivery vehicles purpose built and maintained. Tanker trucks and fuel barges are common sights on roadways and waterways. These bulk product carriers are solely dedicated to transporting one product during that haul unlike carriers for unit products who may mix their cargo to reach maximum capacity. Thus, trucks or barges filled with unit products may transport several different products, such as furniture and televisions, until all usable cargo space has been filled. Mixing cargo increases the unit product carrier's efficiency and profit margin.

However, bulk product carriers are limited to transporting one bulk product during that haul. Additionally, health and safety regulations, issued by regulatory authorities, limit the ability of carriers to change the type of bulk product carried by individual pieces of equipment. Thus, for example, a carrier who places a tanker truck in service for fuel oil may not subsequently use that truck for carrying milk or potable water. Consequently, bulk product carriers have a great need to increase the efficiency of their operations as well as managing the storage of bulk products.

Participant roles in the ownership and replenishment of bulk product stores may be often different than with those of unit quantities. Replenishment of unit quantities generally occurs at the request of the downstream purchaser. Complex business interrelationships between supplier and consumer, such as Just-In-Time delivery, have been employed to create greater efficiency in the delivery and replenishment process.

However, replenishment of a bulk product may not occur at the request of the downstream purchaser. Further, a bulk storage facility may be owned by a supplier, yet located on the property of the product consumer, such as the heating tank in a home that is supplied by a fuel dealer. In such instances, the home owner may simply have contracted to have a steady supply of heating oil delivered by the dealer. Thus, the home owner may never read the tank gauge and replenishment may occur at estimated intervals rather than when needed.

A number of factors can effect oil consumption in a heating system. For example, more fuel oil is used during the winter months when temperatures are low. However, it is also important to consider the efficiency of the heating system as this will impact when the oil tank will need to be refilled. U.S. Pat. No. 6,023,667 (Johnson) is directed toward an oil burner motor diagnostic apparatus for monitoring the running time and cycle time of electric motors to diagnose fuel consumption and burner functionality. However, Johnson fails to disclose or teach a system that allows, for example, for a plurality of fuel dealers to remotely check on the efficiency of customer home heating systems to which they supply home heating fuel.

Still other problems can arise in connection with home heating systems. For example, if a home owner is away from their home and the burner goes out, not only can the temperature in the home drop very low possibly causing the pipes to freeze and rupture, but other serious problems can occur with the heating system. U.S. Pat. No. 5,126,721 (Butcher et al.) is directed toward a flame quality monitor system for oil burners. However, Butcher et al. fails to disclose or teach a system that allows, for example, for a plurality of fuel dealers to remotely check on the status of the burner in a customer home heating system to which they supply home heating fuel.

What is desired, therefore, is an effective system and method for remotely managing a heating system.

### SUMMARY OF THE INVENTION

Accordingly, it is an object of the invention to remotely manage bulk product storage and specifically fuel for a home heating system more efficiently and accurately.

Another object is to provide controlled access to the information collected on each storage location.

A further object is to make the functions of remotely managing bulk product storage available over the internet or wireless communications.

It is further desired to provide a system and method for remotely monitoring the efficiency of a home heating system.

It is still further desired to provide a system and method for remotely monitoring the status of a home heating system.

These and other objects of the invention are accomplished by the provision of a system for providing remotely managed bulk product storage and specifically fuel for a home heating system.

In one embodiment, the system for remotely managing bulk product storage in a storage location includes a computer accessible by a plurality of users; a measurer for measuring the storage level of a bulk product; a data processor associated with the measurer permitting recording of the storage level; a communicator associated with the measurer permitting communication with the computer; an access interface associated with the computer; at least one communications network permitting communication by a user to the computer and permitting communication with the computer by the communicator associated with measurer, a database accessible by the computer containing a plurality of data associated with the storage location; and a plurality of functional software modules executing on the computer for enabling a plurality of users to selectively manipulate the plurality of data associated with the storage location; including an administrative software module for enrolling storage locations and administering the system, a management software module for querying the database, a scheduling software module for scheduling the system, an authorization software module for securing the system.

In another embodiment a centralized fuel monitoring system for allowing a plurality of fuel dealers to monitor the fuel level at customer locations is provided comprising a central computer accessible by a plurality of fuel dealer computers, each fuel dealer having a plurality of customer accounts to which they supply fuel, each fuel dealer having access to the computer to check on the fuel level at the customer location. The system further comprises a measurer installed at a customer location, generating a fuel signal indicative of a fuel level at the customer location and a communicator coupled to the measurer and receiving the fuel signal. The system is provided such that the communicator is coupled to the computer via a communications network, the computer receiving data indicative of the fuel level at the customer location. The system still further comprises authorization software allowing a fuel dealer to access customer accounts associated with the fuel dealer and administration software allowing a fuel dealer to create new customer accounts and enroll new customer locations to be monitored. The system is further provided such that a plurality of fuel dealer computers are able to access the computer, each fuel dealer having a plurality of customer accounts to whom they supply fuel, each fuel dealer accessing the computer system via the authorization software and administering customer accounts via the administration software.

It is contemplated that the efficiency of a home heating system can be monitored by measuring the temperature of the fuel stack as it runs throughout the course of a day. Additionally, the temperature measurements can be taken at varying sampling frequencies to determine the rise time of the temperature, the steady state temperature, the duration of the steady state temperature, and the time between cycles. All of this information may be used to assess the efficiency of the home heating system. This information may be gathered at the customer home and transmitted via a network connection to a central computer to be accessible to a plurality of fuel dealers who may then monitor the efficiency of their customer's heating systems to whom they supply fuel.

Still further, the system may provide for detection of burner lockout by monitoring an alarm signal indicative of a burner lockout. The burner lockout signal may be sent from the customer home to the central computer via a network connection and accessible to a plurality of fuel dealers who may then monitor for burner lockout of their customer's heating systems to whom they supply fuel.

It is further contemplated that the system may provide for a degree day estimate rather than having an actual measurer installed at the customer's home. For example, the central computer may be provided with degree day software for performing a degree day estimate for a particular customer location. The degree day estimate can take into account specific customer location information relating to the customer's home, such as for example, the size of the home, the insulation or insulating rating of the home, the type of heating equipment used, etc. In this manner, a fuel dealer may access the central computer and review a degree day estimate for a particular customer location to which the fuel dealer supplies fuel. It is further contemplated that an actual measurement may occur in another customer location in the geographic vicinity of the degree day estimate customer. The actual fuel level measurement may be used as another factor in determining the degree day estimate. Alternatively, the system could be set up such that a customer could access a degree day estimate for their own home.

In one advantageous embodiment a centralized fuel monitoring system for allowing a plurality of fuel dealers to monitor the fuel level at customer locations is provided comprising a central computer accessible by a plurality of fuel dealer computers, each fuel dealer having a plurality of customer accounts to which they supply fuel, each fuel dealer having access to the central computer to check on the fuel level at the customer location. The system further comprises a measurer installed at a customer location, generating a fuel signal indicative of a fuel level at the customer location and a communicator coupled to the measurer and receiving the fuel signal. The system is provided such that the communicator is coupled to the central computer via a communications network where the central computer receives data indicative of the fuel level at the customer location. The system further comprises authorization software allowing a fuel dealer to access customer accounts associated with the fuel dealer and administration software allowing a fuel dealer to create new customer accounts and enroll new customer locations to be monitored. The system is further provided such that a plurality of fuel dealer computers accesses the central computer, each fuel dealer having a plurality of customer accounts to whom they supply fuel, each fuel dealer accessing the computer system via the authorization software and administering customer accounts via the administration software.

In another advantageous embodiment a centralized fuel monitoring system for allowing a plurality of customers to monitor the fuel level at their customer location is provided comprising a central computer accessible by a plurality of customer computers, each customer having access to the central computer to check on the fuel level at their customer location. The system further comprises a measurer installed at a customer location, generating a fuel signal indicative of a fuel level at the customer location and a communicator coupled to the measurer and receiving the fuel signal. The system is provided such that the communicator is coupled to the central computer via a communications network where the central computer receives data indicative of the fuel level at the customer location. The system further comprises authorization software allowing a customer to access the customer's own account information and administration software allowing a customer to create a new customer account and enroll a new customer location to be monitored. The system is further provided such that a plurality of customer computers accesses the central computer, each customer accessing the central computer system via the authorization software and administering their own accounts via the administration software.

In still another advantageous embodiment a centralized monitoring system for monitoring the status of heating equipment at a customer location is provided comprising a central computer accessible by a plurality of dealer computers, each dealer having a plurality of customer accounts to which they monitor heating systems, each dealer having access to the central computer to check on the status of a heating system at a customer location. The system further comprises a burner monitor installed at a customer location for monitoring the status of a burner in a customer heating system, where the burner monitor generates a burner alarm signal in the event the burner monitor determines an event with the burner in the customer heating system occurs. The system still further comprises a communicator coupled to the burner monitor and receiving the burner alarm signal, where the communicator is coupled to the central computer via a communications network, which receives data indicative of the burner alarm signal at the customer location. The system yet further comprises authorization software allowing a dealer to access the customer's account information and administration software allowing the dealer to create a new customer account and enroll new customer locations to be monitored. The system is provided such that a plurality of dealer computers accesses the central computer, each dealer accessing the central computer system via the authorization software and administering their accounts via the administration software.

In yet another advantageous embodiment a centralized monitoring system for monitoring the efficiency of heating equipment at a customer location is provided comprising a central computer accessible by a plurality of dealer computers, each dealer having a plurality of customer accounts to which they monitor heating systems, each dealer having access to the central computer to check on the efficiency of a heating system at a customer location. The system further comprises an efficiency monitor installed at a customer location for monitoring the efficiency of a customer heating system where the efficiency monitor generates a measurement signal indicative of the efficiency of the customer heating system. The system still further comprises a communicator coupled to the efficiency monitor and receiving the measurement signal, where the communicator is coupled to the central computer via a communications network where the central computer receives data indicative of the measurement signal at the customer location. The system yet further comprises authorization software allowing a dealer to access the customer's account information and administration software allowing the dealer to create a new customer account and enroll new customer locations to be monitored. The system is provided such that a plurality of dealer computers accesses the central computer, each dealer accessing the central computer system via the authorization software and administering their accounts via the administration software.

In still another advantageous embodiment a centralized fuel monitoring system for allowing a plurality of fuel dealers to monitor the fuel level at customer locations is provided comprising a central computer accessible by a plurality of fuel dealer computers, each fuel dealer having a plurality of customer accounts to which they supply fuel and degree day software executing on the central computer estimating the current fuel level at each customer location. The system is provided such that the degree day software estimate for each customer location takes into account specific customer location information relating to the customer's home. The system further comprises authorization software allowing a fuel dealer to access customer accounts associated with the fuel dealer and administration software allowing a fuel dealer to create new customer accounts and enroll new customer locations to be monitored. The system is further provided such that a plurality of fuel dealer computers accesses the central computer, where each fuel dealer has a plurality of customer accounts to whom they supply fuel and each fuel dealer accesses the central computer system via the authorization software and administers customer accounts via the administration software.

In yet another advantageous embodiment a centralized fuel monitoring system for allowing a plurality of customers to monitor the fuel level at their customer location is provided comprising a central computer accessible by a plurality of customer computers and degree day software executing on the central computer estimating the current fuel level at each customer location. The system is provided such that the degree day software estimate for each customer location takes into account specific customer location information relating to the customer's home. The system further comprises authorization software allowing the customer to access their own customer accounts and administration software allowing a customer to create a new customer account and enroll new customer locations to be monitored. The system is further provided such that a plurality of customer computers accesses the central computer, where each customer accesses the central computer system via the authorization software and administers their own customer accounts via the administration software.

Other objects of the invention and its particular features and advantages will become more apparent from consideration of the following drawings and accompanying detailed description.

### BRIEF DESCRIPTION OF THE DRAWINGS

FIG. 1 is a diagram of a system 10 for remotely managing bulk product storage at a storage location in accordance with one embodiment of the invention.

FIG. 1A is a diagram of a system 10 for remotely managing bulk product storage at a storage location in accordance with another embodiment of the invention.

FIG. 2 depicts the administrative software module 30 of system 10 in accordance with one embodiment of the invention.

FIG. 3 depicts the data capture software module 40 in accordance with one embodiment of the invention.

FIG. 4 depicts the management software module 50 of system 10 in accordance with one embodiment of the invention.

FIG. 5 depicts the monitoring software module 60 of system 10 in accordance with one embodiment of the invention.

FIG. 6 depicts the authorization software module 90 of system 10 in accordance with one embodiment of the invention.

FIG. 7 illustrates an embodiment of granting user 11 authorized access to system 10 in accordance with one embodiment of the invention.

### DETAILED DESCRIPTION OF THE INVENTION

Referring now to the drawings, wherein like reference numerals designate corresponding structure throughout the views.

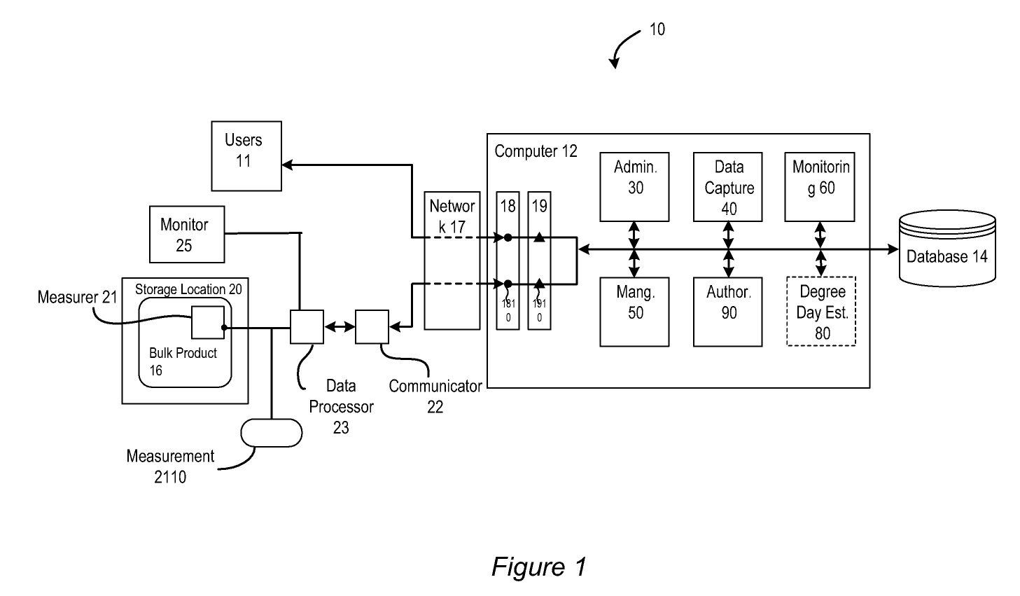

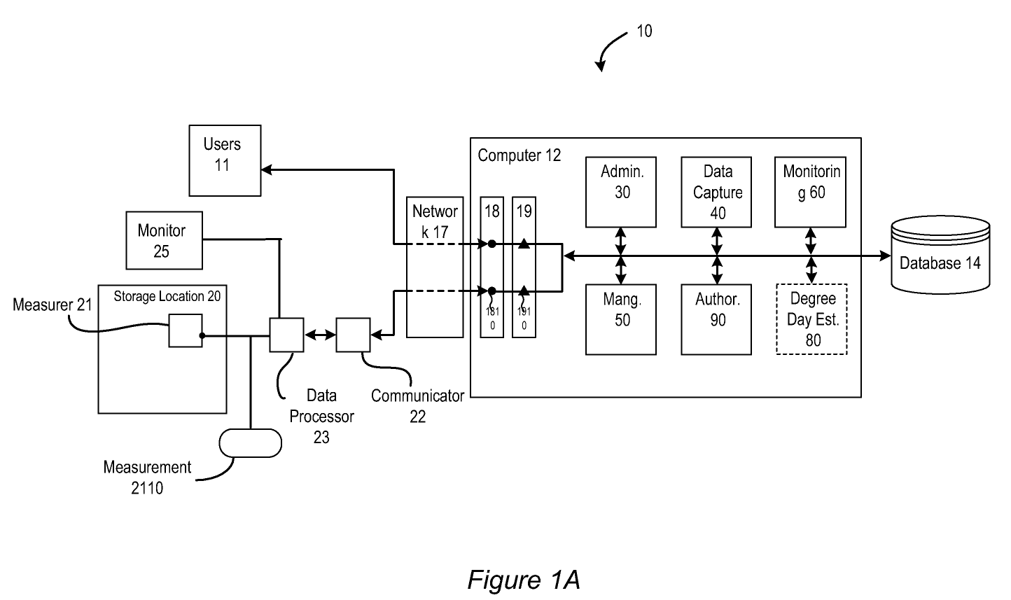

FIG. 1 is a diagram of a system 10 for remotely managing bulk product storage in one storage location in accordance with one embodiment of the invention. System 10 includes one or more users 11 capable of using system 10, a computer 12, one or more databases 14, bulk product 16 at a storage location 20, a communications network 17, an access interface 18 associated with computer 12, one or more software modules 30, 40, 50, 60, 90, and one or more software applications executing on computer 12.

Remotely managing bulk product storage using system 10 in accordance with the invention in a storage location 20 may include monitoring, communicating, exchanging information, and/or performing acts that affect or result in the decision making process that augments, exhausts, manipulates, considers, or in some other way affects the quantity of bulk product 16 at the storage location 20.

Bulk product 16 is defined broadly for this invention in both its form and application and exceeds the dictionary definition of “bulk product.” When used in the singular, the term is equally applicable to the plural.

Bulk product 16 may be liquid such as fuel stored in home or industrial tanks for heating or distribution. Bulk product 16 may be solid such as highway deicing salt at a maintenance depot, grain stored in a silo, or processed cereal stored in quantity for packaging in boxes familiar to supermarket shoppers. Bulk product 16 may also be waste products such as husbandry effluent stored in holding tanks for environment compliance.

The term “bulk product” is also applicable when bulk product 16 comprises two or more discrete products that are stored so as to constitute one product even though they are separable; such as aforementioned cereal, or oil and water, or differently graded aggregate.

The term “bulk product” is further applicable when bulk product 16 is a fungible product; i.e. one that is readily interchangeable with a similar product or by its nature when stored with like product becomes irreversibly miscible; for example electricity stored in a fuel cell, or unrefined petroleum in a salt dome storage facility as are common in the Gulf Coast area. Other uses and/or applications to materials, products or items that will benefit from the invention are also envisioned to be within the invention.

Storage location 20 is defined broadly for this invention and exceeds the dictionary definition of “storage location.” When used in the singular, the term is equally applicable to the plural.

Storage location 20 may be any type of location used to store bulk product 16. It may be stationary. Examples of this kind are the tank hold of a residential oil heating tank or propane tank; the tank hold of a tank in a tank farm as commonly used by petroleum distributors; storage shed in a highway maintenance depot; and basin hold of a water reservoir.

However, storage location 20 may also be movable, such as the hold of a barge carrying bulk products. Storage location 20 may be temporary, such as an aggregate or cement store at a construction site.

Other types of storage locations are also envisioned in accordance with the invention. As for example, in one embodiment, storage location 20 is a delivery vehicle that comes to replenish bulk product 16 at another storage location 20, for example a tanker truck replenishing a fuel oil tank.

Storage location 20 may also be a plurality of locations used to store bulk products 16. Thus, storage location 20 may be all tank holds of all tanks in a tank farm. In such a case, a plurality of the combined quantity of bulk product 16 of tank holds may be important.

Measurer 21 provides measurement 2110 of bulk product 16 in storage location 20. Measurer 21 may be any one or plurality of devices and/or means used to measure the level of the storage of bulk product 16. For example, a pivoting swing arm float level measuring device and/or means capable of converting analog movement to digital signals may be suitable for a fuel tank. Weight and/or laser quantity measurement device and/or means may be suitable for solid bulk products. Pressure measurement device and/or means for a liquefied-gas tank may be suitable for bulk products normally in the gaseous phase at atmospheric pressure. Quantity evacuation measurement device and/or means such as flow meters may be appropriate for storage locations such as water reservoirs that are subject to draw down and variable inflow. An ultrasonic level sensor. Measurer 21 may be any other device and/or means now known or yet to become known for measuring storage levels.

Further, measurer 21 may have certain advantageous features associated with it. Thus, it may be self-contained, i.e. remote battery operated device; be self-activating, self-initiating, and-or self-charging. Therefore, in one embodiment, the measurer 21 is self-activating and initiates contact with computer 12 through associated devices and/or means. Such activation may occur upon a specific time, passage of time, level of bulk product 16, or upon a signal initiated by the delivery of bulk product 16. To preserve battery life, measurer 21 will normally be in the low power deactivated or in the sleep mode.

Associated with measurer 21 is data processor 23. Data processor 23 processes measurement 2110. This may occur by instructing measurer 21 to make a measurement, storing measurement 2110, and/or manipulating measurement 2110 in association with an event or any other process. Data processor 23 may include electronic and logic features capable of recording a plurality of measurement 2110 and executing a variety of advantageous features. Such advantageous features may include being able to associate a plurality of measurement 2110 with other references or data. In one embodiment, data processor 23 associates measurement 2110 with a temporal and/or sequential reference generated by a timer associates with data processor 23.

In another embodiment, data processor 23 associates measurement 2110 with a plurality of data signals received from transponders of deliverers, such as delivery vehicles. These signals may be both predetermined, such as identification, and non-predetermined, such as quantity of bulk product 16 delivered. Data processor 23 may further associate measurement 2110 with a predetermined level of particularity to such a delivery and/or deliverer depending on the need of any type of user 11.

In yet another embodiment, data processor 23 has the ability to compare measurement 2110 with a predetermined storage level, and creating a triggering event. Further, data processor 23 and other means and methods that allow utilizing, and relating collected data to measurement 2110 and/or other data, such as a triggering event.

Data processor 23 may be a flash-memory card, a hard drive as commonly used on computers, a punch card recorder, a biochemical recorder system, or any other device capable of recording data; it may further be a computer, of any size or shape, to perform higher level functions, such as determining from measurement 2110 the relative value of miscible gas components. In one embodiment, data processor 23 may be comprised of a memory capable of storing a plurality of measurement levels 2110. In another embodiment, data processor 23 is additionally capable of recognizing, storing, and/or manipulating data other than measurement 2110, such as delivery date, delivery means, and other data by including a transponder in data processor 23. It will be seen by someone skilled in the art that it is possible to configure data processor 23 to perform an almost unlimited variety of processing tasks associated with system 10.

Computer 12 may be of any type of computing device capable of performing the functions described herein. Computer 12 may be a personal computer, minicomputer, mainframe, supercomputer, web server, or an aggregation of computers in a distributed computer network, or a combination thereof. The computer may be physically located anywhere convenient or expeditious to system 10 or as required by law, regulation, or contract.

Database 14 preferably is a database that is generally known in the art and capable of storing a plurality of files. The invention also encompasses a single database and/or multiple databases; relational, non-relational and/or unique type of database.

It will also be seen by a person skilled in the art that a distributed processing network may be substituted for any part of computer 12 or database 14 or work in conjunction with computer 12 or database 14.

User 11 in system 10 may be an employee or agent of fuel distributor; employee or agent of delivery systems; administrator; manager; researcher, customer service personnel; regulator; accrediting organization; insurer and/or re-insurer; escrow agent; system administrator and/or manager; computer technician; accountant, vendor; subcontractor; and any other person or entity for whom authorized access to the system 10 will be beneficial. Similarly, user 11 in some circumstances may be a computer or computer system that is needed or beneficial for the system 10 or for another user 11, such as the computer of a user's insurer or governmental agency needed for necessary interactions such as regulatory matters. It will also be seen by one skilled in the art, that where one user 11 is shown a plurality may be appropriate, such as when one user 11 is shown, a committee may be appropriate, or a consultant firm, and is included in term “user”.

In one embodiment, user 11 is an employee or agent of a regulatory organization such as a governmental agency charged with environmental protection and compliance. In that instance, the user 11 is monitoring the storage location 20 for regulatory compliance.

In another embodiment, user 11 is an employee or agent of an entity needing to site fungible products in a storage location 20 that may already have similar fungible bulk product 16. In that instance, the user 11 will also need to monitor and authorize the removal of bulk product 16.

In another embodiment, user 11 is an employee or agent of an entity managing the trading of bulk product 16 or the retention of bulk product 16 in escrow.

In another embodiment, user 11 is an employee or agent of an entity operating an exchange for trading of storage potential of storage location 20. Additional users 11 may be purchasers, investors, speculators, sellers, and/or those storing bulk products 16 in storage location 20.

It will be readily seen by one skilled in the relevant art that each user 11 can be provided authorized access, or conversely denied authorized access, to any part or the entire of system 10 according to level or levels or based on individual need or benefit. Access is the capability for the usage of system 10 as represented by the functional software modules of computer 12. Users 11 are given authorized access that may include limitations or qualifications. Qualified access may not be full access, for example qualified access to system 10 may be limited in scope and time and determined uniformly or individually.

It is also readily apparent that the criteria determining, establishing, modifying, withdrawing, or disabling such authorized access can be made ahead of time, and based on one or more factors; such as the function of user 11 or the need of system 10, frequency of that function or need, regulatory compliance, or other reasons.

Conversely, criteria for determining, establishing, modifying, withdrawing, or disabling authorized access can be determined at the time the issue of the access provided to user 11 to system 10 arises. It is equally apparent that alerting, monitoring, analysis, and/or recordation of the use, misuse, and/or abuse of the authorized access privilege may be continuous, intermittent, and/or random and include features that hinder, prevent, or deny opportunity for misuse or abuse of the authorized access privilege. Other features that secure the integrity of system 10 may also be incorporated into system 10. Associated with computer 12 is access interface 18. As used herein, access interface 18 is either hardware or software that permits user 11 and communicator 22 to access the system 10 from a plurality of computer and/or communications protocols. Thus, access interface 18 may be a modem connected to communications network 17. Access interface 18 may also be any other device or devices capable of connecting and communicating with user 11 and/or with communicator 22. It will be apparent to one skilled in the art that access interface 18 can also be a communications portal, such as a web portal.

Associated with measurer 21 is communicator 22. Communicator 22 may be a modem connected to one or more communication networks 17 or any other device capable of connecting and communicating over one or more communication networks 17 now known or to be developed. Communication network 17 may be a wireless voice or data network; a radio receiving, transmitting, or paging network; or a combination thereof, such as Point-to-Multipoint Wide Area Network (WAN), wireless local loop (WLL), or other network types known or to be developed. Preferably, a computer network is linked to communications network 17. Communicator 22 may also be directly linked to computer 12 where this communications network 17 is the direct link. Further, communication network 17 may be a plurality of networks and/or communication devices and/or means.

For example, user 11 may wish to instruct the communicator 22 to perform a device calibration and integrity check. Thus, the communications network 17 may include a computer network link from user 11 to computer 12 and a wireless network link from computer 12 to communicator 22.

The communication integration software 19 operates on computer 12. Communication integration software 19 permits user 11 and communicator 22 utilizing disparate platforms to communicate with the system 10. Disparate platforms are the result of using differing architectures related to hardware and/or software standards employed on microelectronic devices. For example for computers, Digital UNIX maybe the operating system employed on a computer with an Alpha central processor, Hewlett-Packard's HP-UX on a PA-RISC central processor, IBM AIX on a PowerPC based central processing unit, Sun Microsystems' Solaris operating system on a SPARC workstation. Disparate protocols that user 11 or communicator 22 may use also include wireless protocols of varying types; for example: Code Division Multiple Access (CDMA), Carrier Sense Multiple Access/Collision Avoidance (CSMA/CA), Time Division Multiple Access (TDMA), Lightweight & Efficient Application Protocols (LEAP), Global System for Mobil Communications (GSM). Similarly, the disparate protocols may be related to proprietary and patented standards such as Blackberry or Wireless Application Protocol (WAP) or may be related to Side Band Automatic Meter Reading protocols.

Preferably, the communication integration occurs through software executing on the computer 12 that receives various inputs through the communications network 17 for integrating various types of networks, such as Wireless LANs, portable computing clients, or other types of networks known or to be developed. However, the communication integration may also occur through software for interpreting data encoded utilizing an open standard such as the Extensible Mark-up Language (XML). It may also occur through hardware and/or software capable of integrating user 11 and communicator 22 communication protocols for use in accessing the system 10.

In another embodiment, system 10 includes monitor 25. Monitor 25 may be the capability of detecting AC power loss detection or water in the basement alarm, measuring fuel oil burned operation, monitoring burner efficiency, home smoke detectors and alarms, carbon monoxide detectors and alarms, glass break detection and alarm, intrusion detection and alarm, air quality monitoring, regulatory compliance monitoring, and/or any other device, means, or system now known or to be invented and suited for the type of monitoring performed, and an interface or interfaces that connect to data processor 23.

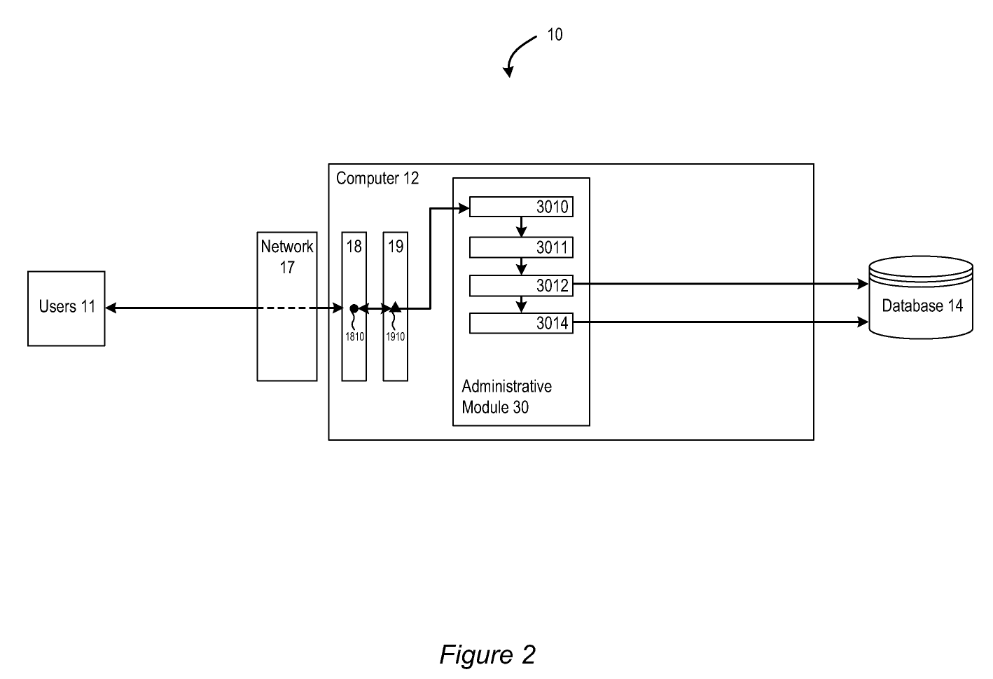

FIG. 2 depicts the administrative software module 30 of system 10 in accordance with one embodiment of the invention. Pre-authorized user 11 accesses computer 12 of system 10 through communications network 17, access node 1810 of access interface 18, and communication integration software process 1910 of communication integration software 19 and is authorized. User 11 completes the necessary enrollment request 3010 of administrative software module 30 to enroll a storage location 20 by disclosing a plurality of storage location data, such as storage potential and means to contact communicator 22 of storage location 20. Request 3010 along with the information that user 11 provided is processed by request process 3011 which creates storage location file 3012 and storage location authenticator 3014. Both are stored on database 14 so that they are associated with each other. Storage location authenticator 3014 will grant appropriate access to the system 10 to data processor 23 which stores a copy of storage location authenticator 3014.

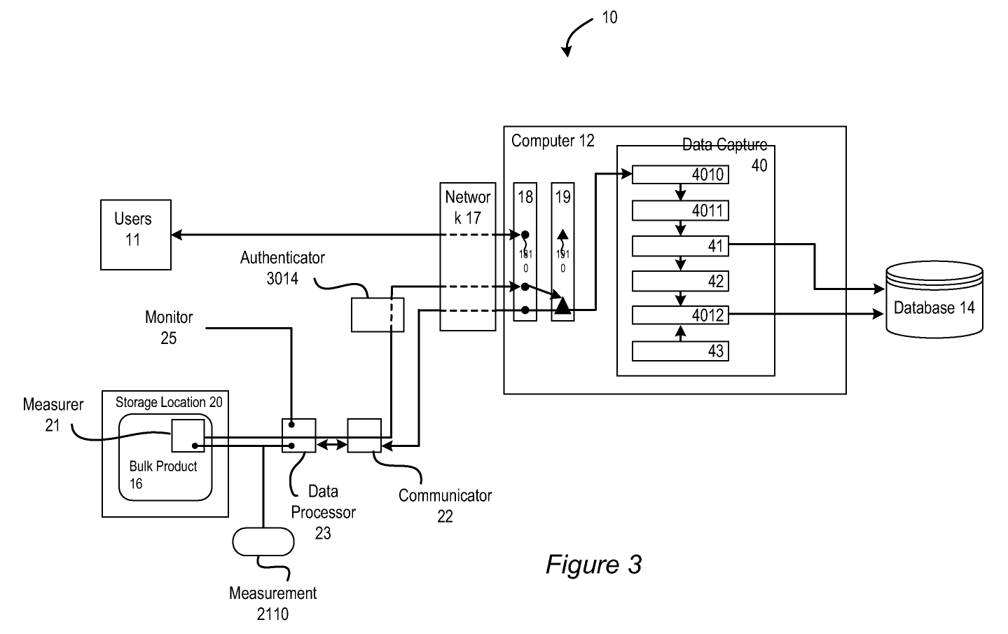

FIG. 3 depicts the data capture software module 40 in accordance with one embodiment of the invention. Data capture software module 40 of computer 12 is initiated upon instruction from user 11 or upon triggering from another software module and contacts and communicator 22 by sending data request 4010 through communications integration process 1910 of communications integration software 19 and access node 1810 of access interface 18. In response, data processor 23 via communicator 22 sends authenticator 3014 by return path and data processor 23 and measurer 21 are authenticated by computer 12 through the use of authenticator 3014. At that time, measurer 21 may be instructed to make a measurement 2110 or instructions may be issued by computer 12 to access storage measurement level data and/or other data previously saved by the data processor 23. The requested information is formatted into data file 4011 stored by data processor 23 is sent by communicator 22 and is forwarded to data capture software module 40. Transmission handler 41 copies data file 4011 to a file repository of database 14 where the data can be backed up and restored. Transmission handler 41 then forwards data file 4011 to data extraction module 42. Data extraction module 42 parses data file 4011 for relevant information and saves the information in a predetermined form in record file 4012. Relevant information for record file 4012 may be any relevant information deemed useful by user 11 and may be predetermined. Data-loading module 48 saves record file 4012 to database 14.

In one embodiment, contact with data capture software module 40 is initiated by the data processor 23 associated with measurer 21. Such contact may be the result of a delivery of bulk product 16 and subsequent triggering of a new measurement 2110 by measurer 21. It may also be the result of scheduled data requests.

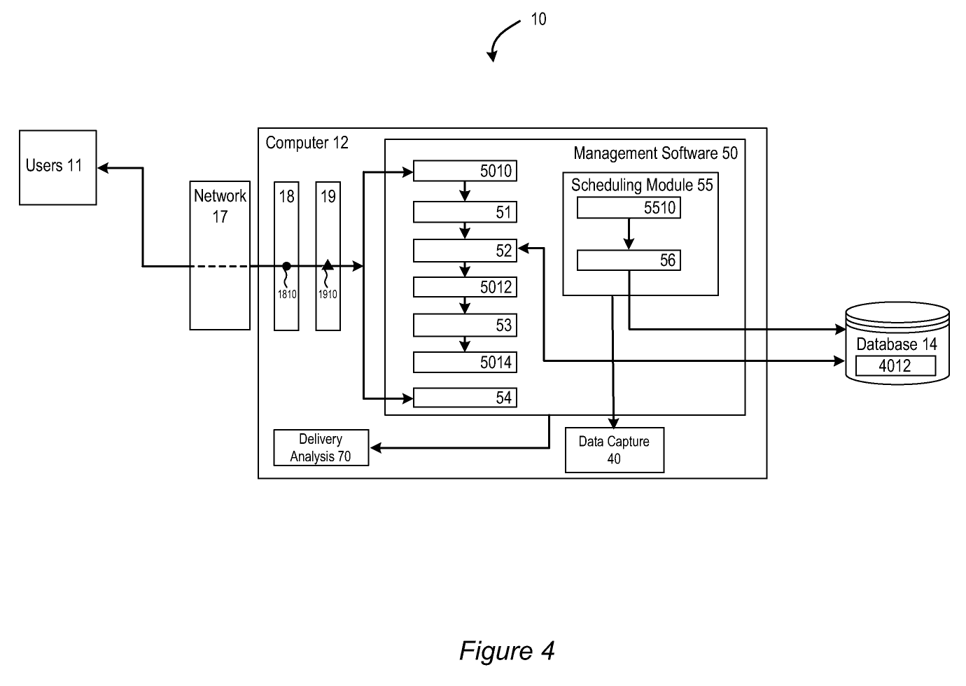

FIG. 4 depicts the management software module 50 of system 10 in accordance with one embodiment of the invention. Pre-authorized user 11 accesses computer 12 of system 10 through communications network 17, access node 1810 of access interface 18, and communication integration software process 1910 of communication integration software 19 and is authorized. User 11 completes query request 5010 of management software module 50. Query builder interface 51 submits query request 5010 to the query builder 52 which queries database 14 for such files as the set of record file 4012. Query builder 51 then retrieves result set 5012. Result set 5012 is the formatted by data formatter 53 into result file 5014 and forwarded to user 11 via query result interface 54.

Further management software module 50 includes scheduling software module 55 of system 10 in accordance with one embodiment of the invention. Pre-authorized user 11 accesses computer 12 of system 10 through communications network 17, access node 1810 of access interface 18, and communication integration software process 1910 of communication integration software 19 and is authorized. User 11 completes schedule request 5510 of scheduling software module 55 to initiate a scheduled activity. Such a request would typically include identification of the storage location scheduling data and any other information deemed pertinent information. Scheduler 56 saves schedule request 5510 to database 14. Upon the scheduled instance in schedule request 5510, scheduling software module 55 passes an instruction file to data capture software module 40 to trigger the module to capture the requested data.

Schedule request 5510 may also be a request for scheduling software module 55 to trigger the creation of a report according to one or more predetermined queries at predetermined times. Thereby, upon the scheduled instance in schedule request 5510, scheduling software module 55 passes an instruction file to management software module 50 to create query request 5010 within the predetermined parameters of schedule request 5510.

In one embodiment, software module 50 includes an accounting software, such as accounting module, that allows for generating billing and remittances, including credit card authorizations. Such accounting software may further have the ability to calculate and determine an annual-averaged bill on a periodic basis.

In one embodiment, software module 50 includes reporting software, such as reporting module, that according to a predetermined protocol report send the results of a query, result file 5014, via communication network 17 in the form of an e-mail, a fax, or a voice mail message, or generate a web page, such as an active server page, ftp, or any other method.

Associated with management software module 50 is delivery analysis software module 70. Delivery analysis software module 70 may include one or a plurality of software modules, such as route optimization, geographical information and/or positioning systems, personnel management, and/or any other software and/or system that allow further management and/or reporting of data associate with system 10, preferably but not necessarily limited to data associated to the delivery and/or replenishment of bulk product 16 of storage location 20.

In one preferred embodiment, software module 70 includes a route optimization software, such as route optimization module, that permit deliveries to be scheduled according to threshold storage levels of bulk product 16.

In one embodiment, software module 70 includes a geographical information system or an access interface to such a system and would be accessible over communications network 17 through the Internet, via wireless web enabled system, an/or any other convenient device and/or means. The geographical information system would associate geographical positions of storage locations, geographical positions of deliverers to known geographical data. Available and useful data may be transportation routes such as roadways, pipelines, and waterways, and their relative levels of congestion. Associated with that data in geographical information system may be route limitations, such as bridge weight or clearance limits, waterway limits on hazardous material shipment and/or other data useful and/or pertinent.

In one embodiment, software module 70 includes a personnel management system that has the ability to schedule personnel within the limitations set by regulatory authorities, such as 49 CFR 350.

It will be seen by someone skilled in the art that other management and software modules may be included.

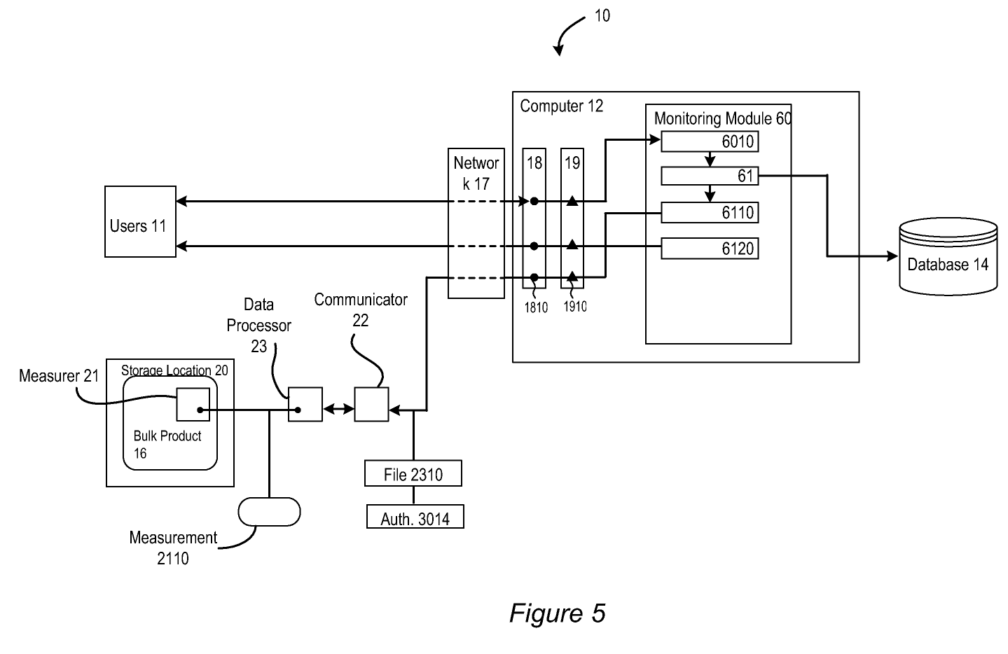

FIG. 5 depicts the monitoring software module 60 of system 10 in accordance with one embodiment of the invention. Pre-authorized user 11 has previously enrolled storage location 20 in system 10 and created monitoring file 6010 which has been saved to database 14. Monitoring file 6010 may include all such information user 11 finds useful to be monitored. For example, if user 11 is a fuel oil distributor who has entered into an exclusive supply contract, the distributor may wish to guard against rogue deliveries. Distributor user 11 enrolls the storage location 20 for bulk product 16, a tank hold, and installs measurer 21, data processor 23, and communicator 22 associated with storage location 20. Distributor user 11 then completes monitoring file 6010 which monitoring software module 60 saves to database 14. Monitoring process 61 then forwards instruction file 6110 to data processor 23 using the communications path of communication integration software process 1910 of communication integration software 19, access node 1810 of access interface 18, and communication network 17 to communicator 22. Data processor 23 saves instruction file in its memory. When bulk product 16 is filled, it causes measurer 21 to take measurement 2110 which measurer 21 forwards to data processor 23. Data processor 23 is so configured that it recognizes that measurement 2110 exceeds parameters set in instruction file 6110. Data processor 23 configures a result file, file 2310, and by return path to computer 10 sends file 2310 along with previously-stored storage location authenticator 3014. Monitoring software module 60 then analyzes file 2310 and sends an alert 6120 to user 11 informing him that the parameters created in monitoring file 6010 have been exceeded. User 11 the may take action or further use system 10 such as accessing data base 14 by creating queries and analyzing results further.

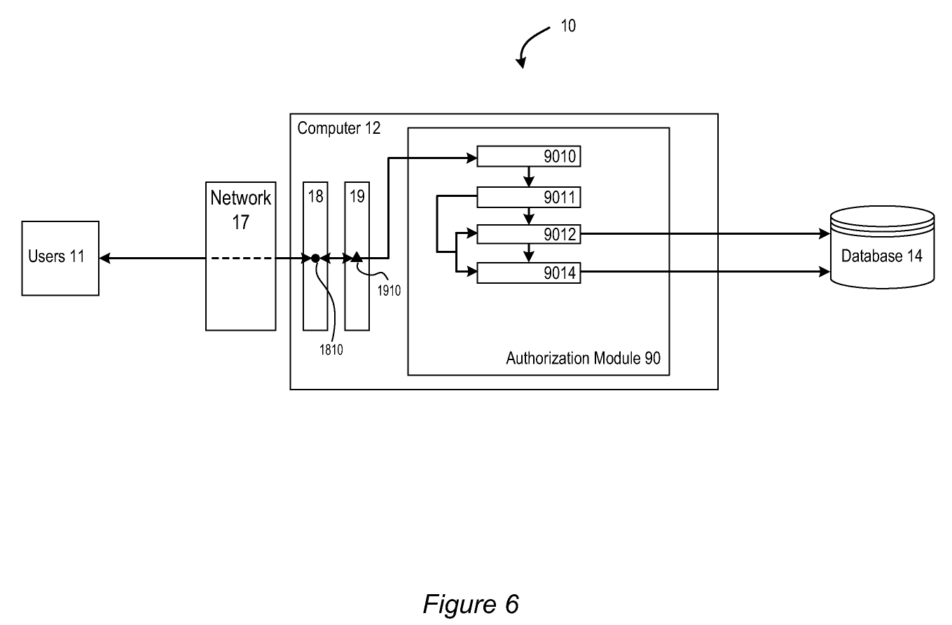

FIG. 6 depicts the authorization software module 90 of system 10 in accordance with one embodiment of the invention. Authorization software module 90 secures system 10 by managing the authorization and granting of authorization with and/or without human intervention of a system administrator. Unauthorized user 11 accesses computer 12 of system 10 through communications network 17, access node 1810 of access interface 18, and communication integration software process 1910 of communication integration software 19. User 11 who requests authorization receives qualified access to system 10 from authorization software module 90. Using the qualified access and using system 10, user 11 completes the necessary authorization request 9010, such as an application, and/or specific professional, and biographic information. Request 9010 along with the information user 11 provided is processed by request process 9011 which creates user file 9012 and authenticator 9014. Both are stored on database 14 so that they are associated with each other.

If user 11 is approved by a verification process, user 11 will be issued authenticator 9014 that will grant appropriate access to the system 10. Authenticators that may be employed for a user 11 are known to be password, pass code, voice recognition, smart card technology, or biometric recognition. The appropriateness of assigning the type of authenticator 9014 can be determined according to standards understood by one skilled in the art and predetermined by the institution and/or in compliance with external constraints.

The authorization process may include a proscribed verification process that may be attuned to the information supplied and/or level of access sought. The process for verifying the information is determined through available means and channels, such as record databases external and internal to the system 10.

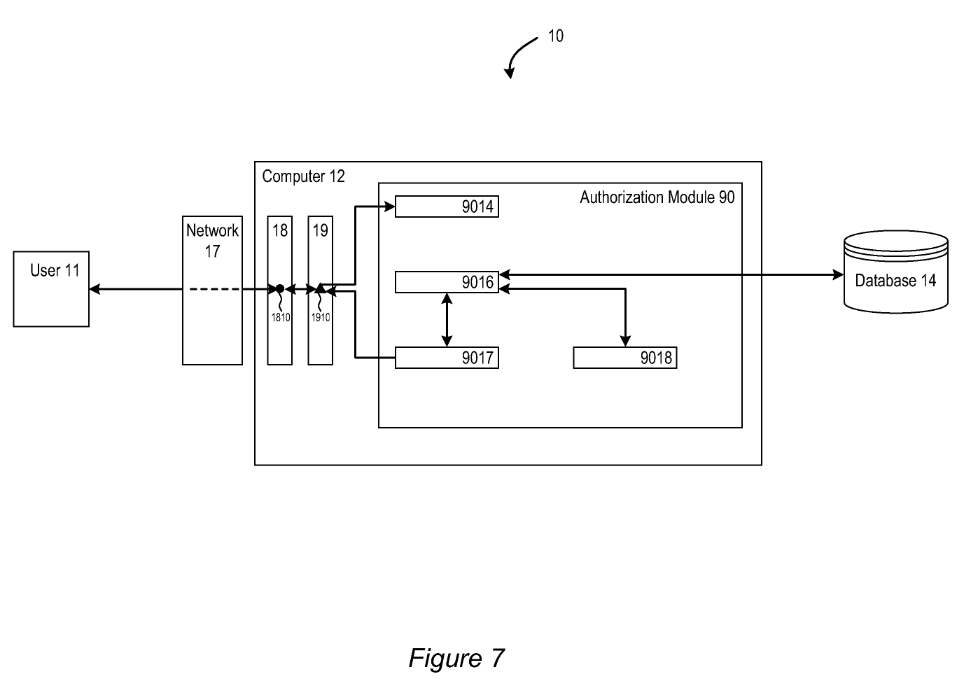

FIG. 7 illustrates an embodiment of granting user 11 authorized access to system 10. User 11 accesses computer 12 of system 10 through communications network 17 and access node 1810 of access interface 18 and communication integration software process 1910 of communication integration software 19. Upon request of computer 12 user 11 provides previously issued authenticator 9014. Computer 12 verifies authenticator 9014 through authentication process 9016 which queries database 14 for a copy of authenticator 9014. Upon verification computer 12 grants access by access process 9017 or upon failure to verify denies access at denial process 9018.

Referring back to FIG. 1 system 10 including computer 12 is optionally provided with degree day estimate software 80. It is contemplated that degree day estimate software 80 will take into account various specific customer location information relating to the customer's home. This customer location information could include, such as for example, the size of the home, the insulation or insulating rating of the home taking into account the type of insulation and the type of size of windows in the home, the type of heating equipment used including an efficiency rating and the like. In this manner, a specific rating for the home can be used in determining the degree day estimate. As illustrated in FIG. 1, a user 11 could access computer 12 via network connection 17 to access the degree day estimate for a particular customer location. In on embodiment, user 11 may comprise a fuel dealer that supplies fuel to a customer location, in another embodiment, user 11 may comprise the customer to whom fuel is supplied.

In another embodiment, it is contemplated that a first customer may utilize degree day estimate software 80 as described above. Additionally, a second customer, in a similar geographical location to the first customer, may utilize the system including measurer 21 as described earlier to generate a measurement 2110 at the second customer location. The measurement 2110 may then be used by degree day estimate software 80 to determine a degree day estimate for the first customer.

Referring now to FIG. 1A, system 10 including computer 12 is optionally provided to monitor the efficiency of, for example, a home heating system. Measurer 21 is provided at the storage location 20 and is provided to measure the temperature of a fuel stack as it runs throughout the course of a day. From this measurement, the efficiency of the heating system can be determined. It is further contemplated that the temperature measurements can be taken at varying sampling frequencies to determine the rise time of the temperature, the steady state temperature, the duration of the steady state temperature, and the time between cycles to provide very accurate information. This data may be gathered at the customer location via measurer 21 and transmitted to computer 12 via network 17, which is accessible to users 11.

In still another embodiment, the system 10 may utilize measurer 21 to monitor for detection of burner lockout. This could be accomplished, for example, by having measurer 21 monitor an alarm signal indicative of a burner lockout. The burner lockout signal may be sent from the customer location to computer 12 via network 17 to be accessible to users 11.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A centralized fuel monitoring system for allowing a plurality of fuel dealers to monitor the fuel level at customer locations comprising:
a central computer accessible by a plurality of fuel dealer computers, each fuel dealer having a plurality of customer accounts to which they supply fuel, each fuel dealer having access to said central computer to check on the fuel level at the customer location;
a measurer installed at a customer location, generating a fuel signal indicative of a fuel level at the customer location;
a communicator coupled to said measurer and receiving the fuel signal;
said communicator coupled to said central computer via a communications network, said central computer receiving data indicative of the fuel level at the customer location;
authorization software allowing a fuel dealer to access customer accounts associated with the fuel dealer; and
administration software allowing a fuel dealer to create new customer accounts and enroll new customer locations to be monitored;
wherein a plurality of fuel dealer computers access the central computer, each fuel dealer having a plurality of customer accounts to whom they supply fuel, each fuel dealer accessing the central computer system via the authorization software and administering customer accounts via the administration software.

2. The fuel monitoring system of claim 1 further comprising a customer computer coupled to said central computer, wherein each customer has access to their own account information.

3. The fuel monitoring system of claim 2 wherein each customer has access to the fuel level at their customer location.

4. The fuel monitoring system of claim 1 further comprising delivery analysis software for analyzing replenishment of fuel at the customer location.

5. The fuel monitoring system of claim 1 wherein the system provides the dealer with geographical information for customer route optimization.

6. The fuel monitoring system of claim 1 further comprising accounting software for generating billing information associated with the customer account.

7. The fuel monitoring system of claim 1 wherein said communicator is wirelessly coupled to said measurer.

8. A centralized fuel monitoring system for allowing a plurality of customers to monitor the fuel level at their customer location comprising:
a central computer accessible by a plurality of customers computers, each customer having access to said central computer to check on the fuel level at their customer location;
a measurer installed at a customer location, generating a fuel signal indicative of a fuel level at the customer location;
a communicator coupled to said measurer and receiving the fuel signal;
said communicator coupled to said central computer via a communications network, said central computer receiving data indicative of the fuel level at the customer location;
authorization software allowing a customer to access the customer's own account information; and
administration software allowing a customer to create a new customer account and enroll a new customer location to be monitored;
wherein a plurality of customer computers access the central computer, each customer accessing the central computer system via the authorization software and administering their own accounts via the administration software.

9. The fuel monitoring system of claim 8 further comprising delivery analysis software for analyzing replenishment of fuel by a dealer at the customer location.

10. The fuel monitoring system of claim 8 wherein the system provides a dealer with geographical information for route optimization.

11. The fuel monitoring system of claim 8 further comprising accounting software for generating billing information associated with the customer account.

12. The fuel monitoring system of claim 8 wherein said communicator is wirelessly coupled to said measurer.

13. A centralized monitoring system for monitoring the status of heating equipment at a customer location comprising:
a central computer accessible by a plurality of dealer computers, each dealer having a plurality of customer accounts to which they monitor heating systems, each dealer having access to said central computer to check on the status of a heating system at a customer location;
a burner monitor installed at a customer location for monitoring the status of a burner in a customer heating system;
said burner monitor generating a burner alarm signal in the event said burner monitor determines an event with the burner in the customer heating system occurs;
a communicator coupled to said burner monitor and receiving the burner alarm signal;
said communicator coupled to said central computer via a communications network, said central computer receiving data indicative of the burner alarm signal at the customer location;
authorization software allowing a dealer to access the customer's account information; and
administration software allowing the dealer to create a new customer account and enroll a new customer locations to be monitored;
wherein a plurality of dealer computers access the central computer, each dealer accessing the central computer system via the authorization software and administering their accounts via the administration software.

14. The fuel monitoring system of claim 13 further comprising a customer computer coupled to said central computer, wherein each customer has access to their own account information.

15. The fuel monitoring system of claim 13 further comprising accounting software for generating billing information associated with the customer account.

16. The fuel monitoring system of claim 13 wherein said communicator is wirelessly coupled to said burner monitor.

17. A centralized monitoring system for monitoring the efficiency of heating equipment at a customer location comprising:
a central computer accessible by a plurality of dealer computers, each dealer having a plurality of customer accounts to which they monitor heating systems, each dealer having access to said central computer to check on the efficiency of a heating system at a customer location;
an efficiency monitor installed at a customer location for monitoring the efficiency of a customer heating system;
said efficiency monitor generating a measurement signal indicative of the efficiency of the customer heating system;
a communicator coupled to said efficiency monitor and receiving the measurement signal;
said communicator coupled to said central computer via a communications network, said central computer receiving data indicative of the measurement signal at the customer location;
authorization software allowing a dealer to access the customer's account information; and
administration software allowing the dealer to create a new customer account and enroll a new customer locations to be monitored;
wherein a plurality of dealer computers access the central computer, each dealer accessing the central computer system via the authorization software and administering their accounts via the administration software.

18. The fuel monitoring system of claim 17 further comprising a customer computer coupled to said central computer, wherein each customer has access to their own account information.

19. The fuel monitoring system of claim 17 further comprising accounting software for generating billing information associated with the customer account.

20. The fuel monitoring system of claim 17 wherein said communicator is wirelessly coupled to said efficiency monitor.

21. A centralized fuel monitoring system for allowing a plurality of fuel dealers to monitor the fuel level at customer locations comprising:
a central computer accessible by a plurality of fuel dealer computers, each fuel dealer having a plurality of customer accounts to which they supply fuel;
degree day software executing on the central computer estimating the current fuel level at each customer location;
said degree day software estimate for each customer location taking into account specific customer location information relating to the customer's home;
authorization software allowing a fuel dealer to access customer accounts associated with the fuel dealer; and
administration software allowing a fuel dealer to create new customer accounts and enroll new customer locations to be monitored;
wherein a plurality of fuel dealer computers access the central computer, each fuel dealer having a plurality of customer accounts to whom they supply fuel, each fuel dealer accessing the central computer system via the authorization software and administering customer accounts via the administration software.

22. The fuel monitoring system of claim 21 further comprising a customer computer coupled to said central computer, wherein each customer has access to their own account information.

23. The fuel monitoring system of claim 21 further comprising delivery analysis software for analyzing replenishment of fuel at the customer location.

24. The fuel monitoring system of claim 21 wherein the system provides the dealer with geographical information for customer route optimization.

25. The fuel monitoring system of claim 21 further comprising accounting software for generating billing information associated with the customer account.

26. The fuel monitoring system of claim 21 further comprising:
a measurer installed at a first customer location, generating a fuel signal indicative of a fuel level at the first customer location; and
a communicator coupled to said measurer and receiving the fuel signal;
said communicator coupled to said central computer via a communications network, said central computer receiving data indicative of the fuel level at the first customer location;
wherein the system utilizes the fuel signal from the first customer location as a factor in determining said degree day software estimate for a second customer location in the geographic vicinity of the first customer location.

27. A centralized fuel monitoring system for allowing a plurality of customers to monitor the fuel level at their customer location comprising:
a central computer accessible by a plurality of customer computers;
degree day software executing on the central computer estimating the current fuel level at each customer location;
said degree day software estimate for each customer location taking into account specific customer location information relating to the customer's home;
authorization software allowing the customer to access their own customer accounts; and
administration software allowing a customer to create a new customer account and enroll new customer locations to be monitored;
wherein a plurality of customer computers access the central computer, each customer accessing the central computer system via the authorization software and administering their own customer accounts via the administration software.

28. The fuel monitoring system of claim 27 further comprising delivery analysis software for analyzing replenishment of fuel by a dealer at the customer location.

29. The fuel monitoring system of claim 27 wherein the system provides a fuel dealer with geographical information for customer route optimization.

30. The fuel monitoring system of claim 27 further comprising accounting software for generating billing information associated with the customer account.

31. The fuel monitoring system of claim 27 further comprising:
a measurer installed at a first customer location, generating a fuel signal indicative of a fuel level at the first customer location; and
a communicator coupled to said measurer and receiving the fuel signal;
said communicator coupled to said central computer via a communications network, said central computer receiving data indicative of the fuel level at the first customer location;
wherein the system utilizes the fuel signal from the first customer location as a factor in determining said degree day software estimate for a second customer location in the geographic vicinity of the first customer location.
